(19) United States
(12) Patent Application Publication
(10) Pub. No.: US 2024/0110621 A1
(43) Pub. Date: Apr. 4, 2024

(54) DRIVE AXLE ASSEMBLY WITH LUBRICANT BAFFLE

(71) Applicant: DANA ITALIA S.R.L., Arco (Trento) (IT)

(72) Inventors: Federico BAVARESCO, Arco (IT); Giulio VELLERE, Arco (IT)

(21) Appl. No.: 18/476,182

(22) Filed: Sep. 27, 2023

(30) Foreign Application Priority Data
Sep. 28, 2022 (DE) 20 2022 105 477.0

(51) Int. Cl. F16H 57/04; B60K 17/34; F16H 48/38

(52) U.S. Cl. CPC F16H 57/0423; B60K 17/34; F16H 48/38; F16H 57/0483; F16H 2048/385; F16H 57/037

(57) ABSTRACT

The present disclosure relates to a drive axle assembly, comprising:
a differential assembly including a pinion gear and a crown gear, the pinion gear configured to drive the crown gear and the crown gear rotatable about a rotation axis, and
   a lubricant baffle,
wherein the lubricant baffle axially overlaps with the pinion gear and faces a toothed front face of the crown gear, and
wherein the lubricant baffle has, with respect to the rotation axis of the crown gear, an axial dimension, a radial dimension and a circumferential dimension, the axial dimension being smaller than the radial dimension and the circumferential dimension.
   The present disclosure further relates to a set including two drive axle assemblies of the aforementioned type.

### CROSS-REFERENCE TO RELATED APPLICATION

The present application claims priority to German Utility Model Application No. 20 2022 105 477.0, entitled, “DRIVE AXLE ASSEMBLY WITH LUBRICANT BAFFLE”, and filed Sep. 28, 2022. The entire contents of the above-listed application is hereby incorporated by reference for all purposes.

### TECHNICAL FIELD

The present disclosure concerns a drive axle assembly for a vehicle, such as a road vehicle and more specifically a heavy-duty vehicle and/or an off-highway vehicle. The present disclosure further concerns a set of drive axle assemblies each having a lubricant baffle.

### BACKGROUND & SUMMARY

Lubricated drive axle assemblies are widely used in the prior art, for example in connection with differentials. While the lubricant (e.g. oil) provides significant benefits in terms of limiting mechanical contact forces and abrasion, its use is accompanied with certain challenges. For example, it is known that during operation of the drive axle assembly the lubricant provides a resistance against the rotation of gears of the drive axle assembly. This may lead to losses of mechanical energy, such as when significant lubricant splashes occur.

To reduce such losses, it is known to provide lubricant baffles that help to limit lubricant splashes and/or help to guide lubricant streams in a desired manner. An example can be found in DE 10 2011 003 221 A1. This lubricant baffle, however, is a large part having a complex three-dimensional shape for enclosing various components of the drive axle assembly. This is accompanied with high manufacturing costs of the lubricant baffle and complicates assembly and packaging of the drive axle assembly. Also, it has been determined that such lubricant baffles are not able to prevent certain performance limiting effects associated with the lubricant (see below).

Still further, known lubricant baffles are typically shaped and dimensioned to be usable in one specific type of drive axle assembly only. This means that for every drive axle assembly, one individual type of lubricant baffle has to be constructed, produced and stored. This increases the costs of the drive axle assembly.

Thus, there is demand for a drive axle assembly having a lubricant baffle with reduced costs and limited complexity which enables an efficient operation of the drive axle assembly.

This demand is met by a drive axle assembly as described herein.

The presently proposed drive axle assembly comprises:
a differential assembly including a pinion gear and a crown gear, the pinion gear configured to drive the crown gear and the crown gear rotatable about a rotation axis, and
a lubricant baffle,
wherein the lubricant baffle axially overlaps with the pinion gear and faces a toothed front face of the crown gear, and
wherein the lubricant baffle has, with respect to the rotation axis, an axial dimension, a radial dimension and a circumferential dimension, the axial dimension being smaller than the radial dimension and the circumferential dimension, for example, smaller than 50%, smaller than 25%, smaller than 10%, smaller than 1% or at most 5% of the radial dimension and/or of the circumferential dimension.

The drive axle assembly may further include a drive axle housing which houses the differential assembly. Or put differently, the differential assembly may be diposed within the drive axle housing.

Typically, the differential assembly further includes a plurality of differential gears or spider gears configured to be driven by the crown gear. And the differential assembly may include a first side gear and a second side gear drivingly engaged with the differential gears. Usually, the side gears are coupled to a first driven shaft and to a second driven shaft, respectively.

The circumferential dimension may be larger than the radial dimension (e.g. at least 1.5 times as large or at least twice as large). In this way, the lubricant baffle may cover a large angular sector of the front face of the crown gear with the lubricant baffle.

Any of the above dimensions of the lubricant baffle may concern a maximum dimension in a respective direction, e.g. a maximum axial dimension, a maximum radial dimension and a maximum circumferential dimension. The radial direction may extend at an angle and for instance orthogonally to the rotation axis of the crown gear. The circumferential direction may extend around or about said rotation axis. Generally, any references to axial, radial and circumferential directions when used herein may refer to the rotation axis of the crown gear, even when they do not concern a dimension of the lubricant baffle.

The drive axle housing may also house the lubricant baffle. The first and second driven shaft (that may optionally be part of the drive axle assembly and e.g. be coupled to the differential gears) may at least partially be housed in the drive axle housing. This may e.g. apply to one end of each of the first and second driven shaft that reaches into the drive axle housing for being coupled with the differential assembly.

The drive axle housing may comprise a main part, for instance made of a metallic material, such a cast iron. It may comprise an opening through which an input shaft for driving the pinion gear may reach. It may comprise an opening (e.g. an opened axial end face) through which the first driven shaft extends and/or another opening (e.g. another opened axial end face) through which the second driven shaft extends. Any one of these openings may be used for insertion and assembly of any of the components housed by the drive axle housing, such as insertion and assembly of the crown gear and/or the of the lubricant baffle. Additionally or alternatively, any of these openings may be covered by a side cover of the drive axle housing that is fixed to the main part of the drive axle housing.

The crown gear may also be referred to and/or may be configured as a ring gear. It may have a toothed front face and a non-toothed rear face. The front face and rear face may both be axial faces. The crown gear may mesh with the pinion gear at a position that is at a radial distance from the crown gear's rotation axis. Put differently, the crown gear's teeth may be circumferentially distributed about and at a radial distance from said rotation axis. The crown gear and the pinion gear may define a bevel gear set. The crown gear and the pinion gear and their rotational envelopes may define a bevel gear set ratio.

The input shaft may extend radially and/or its rotation axis may extend at an angle and may be orthogonally to the rotation axis of the crown gear. The pinion gear may also be referred to or may be configured as a bevel gear.

Each of the first and second driven shaft may rotate about the same rotation axis as the crown gear or about a rotation axis that extends in parallel to the crown gear's rotation axis. Each of the first and second driven shaft may be configured as or may be coupled to an axle, e.g. a half axle. Each of the first and second driven shaft may be configured to drive a vehicle wheel.

The inventors have discovered that for effectively limiting mechanical losses caused by the lubricant within the drive axle assembly, it can be sufficient to provide a lubricant baffle with limited dimensions compared to the prior art and by positioning it in the manner disclosed herein. Specifically, it has been determined that by means of the comparatively axially thin and thus lightweight and cheap lubricant baffle disclosed herein, splashes can be effectively limited.

In more detail, it has been discovered that when operating the drive axle assembly, the lubricant may be non-uniformly distributed within the drive axle assembly, due to being forced (e.g. pumped) by rotating parts towards certain areas of the drive axle assembly. The crown gear and the bevel set formed by the crown gear and pinion gear may exert large forces on the lubricant, causing oil splashes against the interior of the axle housing. Also, the lubricant may significantly heat up. As a result, heated-up lubricant may accumulate in certain areas of the drive axle assembly which may lead to the drive axle assembly heating up non-uniformly. This can cause locally increased wear of components of the drive axle assembly, such as of seals, as well as a degradation of the lubricant itself. Without the disclosed lubricant baffle, the vehicle would have to be stopped or its speed would have to be reduced to prevent such damages and degradation.

Furthermore, by providing the lubricant baffle with the claimed dimensional relations (and for example by, according to embodiments discussed below, configuring it with a plate-shape or as not enclosing or overlapping with the crown gear) the lubricant baffle can be fitted into a number of different drive axle assemblies. For example, it may be provided in a variety of different drive axle assemblies, even when these have e.g. different axial positions of the crown gear and/or different bevel said gear ratios. This increases the range of possible uses of the lubricant baffle. Such a range of possible uses is typically not possible with lubricant baffles having complex three dimensional shapes and enclosing certain components of the drive axle assembly.

As detailed below, positioning the lubricant baffle so as to axially overlap with the pinion gear (e.g., so that at least parts thereof are arranged at identical axial positions) further improves said range of uses. For example, this way the crown gear can be positioned on either axial side of the lubricant baffle.

In one example, the lubricant baffle comprises or is made of a plastic material or a metallic material.

The drive axle assembly may optionally comprise any of the further members discussed in connection therewith, such as the driven shafts or the input shaft.

According to one embodiment, the lubricant baffle is plate shaped and may be a plate that is e.g. cut out from a material sheet. For example, the lubricant baffle may extend in one main plane, said plane e.g. extending orthogonally to the rotation axis. The lubricant baffle may be substantially planar, but may have local and/or compact recesses or protrusions. The axial dimension of the lubricant baffle may define a thickness of the plate (or the plate shape). The circumferential dimension and the radial dimension may define the main plane. In other words, they may be dimensions of said main plane. Providing a respective plate shape simplifies production and limits the size of the lubricant baffle.

Additionally or alternatively, the lubricant baffle may define, comprise or be shaped corresponding to a ring segment, such as a substantially planar ring segment. It may thus have largely or fully arc-shape radially outer and/or inner edges. These edges may extend concentrically with respect to and/or may extend about the crown gear's rotation axis. The ring segment shape does not exclude that a section of any of the radially outer and/or inner edge is straight or deviates from the arc shape along a limited length. This may still be regarded as a shape that substantially corresponds to that of a ring segment, such as when one of the inner and outer edge is still fully shaped according to an arc shape.

According to another embodiment, the lubricant baffle does not extend past the toothed front face of the crown gear along the rotation axis. For instance, the lubricant baffle may be disposed at an axial distance from the crown gear. Put differently, the lubricant baffle may not axially overlap with the crown gear. This may reduce the size of the lubricant baffle as well as the complexity of its shape.

In one embodiment, the lubricant baffle does overlap with the crown gear along the rotation axis of the crown gear. That is, the lubricant baffle may be disposed at a distance from the crown gear long the rotation axis of the crown gear. Specifically, the lubricant baffle may not face a circumferential outer face of the crown gear. Instead, the lubricant baffle may extend as a cover-type or shield-type member in front of the crown gear's front face, e.g. without axially extending past or axially overlapping with said front face. For instance, the lubricant baffle may not enclose and/or may not house the crown gear.

The lubricant baffle may largely or fully extend below of a static lubricant level in the drive axle housing. Said static lubricant level may correspond to a set level e.g. according to recommendations by a manufacturer of the drive axle assembly. In one example, at least 50% or at least 75% of the circumferential dimension of the lubricant baffle may extend below of said static lubricant level. This ensures a sufficient immersion of the lubricant baffle in the lubricant to guide and/or obstruct the lubricant's movements in a desired manner.

According to one aspect, the lubricant baffle is fixed to the drive axle housing, such as at a position that is below of a static lubricant level in the drive axle housing. Positioning the fixation accordingly helps to ensure a significant immersion of the lubricant baffle in the lubricant. In this context, it may be provided that a radial outer edge of the lubricant baffle is fixed to the drive axle housing.

Generally, the lubricant baffle may be mechanically fixed to the drive axle housing, e.g. by means of a mechanical fixing element, such as a screw or a bolt. For doing so, it may comprise a trough hole for receiving a respective mechanical fixing element. Said through-hole may be aligned with a through hole in the drive axial housing. Said through hole of the drive axle housing may e.g. be provided at an interior surface and/or in an internal projection or internal boss of the drive axle housing.

According to one embodiment, the lubricant baffle faces at least a segment of the crown gear's front face along the complete length of the teeth of said segment. Put differently, the lubricant baffle may extend along a complete radial dimension of a toothed segment of the crown gear. This helps to significantly reduce lubricant splashes.

In one example, the circumferential dimension of the lubricant baffle is less than 270°, and may be less than 220° or less than 180°. Put differently, the lubricant baffle may extend within and/or cover an angular section of less than 270°, and may be less than 220° or less than 180°. It has been found that an efficient reduction of lubricant splashes can still be achieved while limiting the circumferential extension accordingly (and thus limiting the overall size, costs and weight of the lubricant baffle). Also, the respective size limitation ensures the mountability of the lubricant baffle which e.g. has to be inserted through openings or open end faces into the drive axle housing.

As indicated above, it may be provided that the majority of the surface area of the lubricant baffle is below of a static lubricant level.

In one example, the lubricant baffle comprises at least one outer edge portion that is at a radial distance from an inner wall of the drive axle housing. For instance, said outer edge portion may be comprised by a cut-out. In other words, there may be at least one cut-out in a portion of the baffle that faces an inner wall of the drive axle housing, the edge of said cut-out forming an outer edge of the lubricant baffle and being at a radial distance from said inner wall. In still other words, the lubricant baffle may comprises at least one cut-out (e.g. according to the above examples) that acts as a lubricant passage.

By way of the cut-out, lubricant may pass from one side of the lubricant baffle to the other. This may provide a defined flow and thus exchange of lubricant to limit local overheating, while still enabling a significant reduction of lubricant splashes.

According to one embodiment, the lubricant baffle is positioned in an axial central region of the drive axle assembly, and may be of the drive axle housing. This may refer to a region at, adjacent to and/or comprising a centre along an axial dimension of the drive axle assembly, and may be of the drive axle housing. For instance, the lubricant baffle may be positioned closer to said centre than to one of (e.g. vertical) side walls or axial outer ends of the drive axle housing. The axial central region may comprises an axial centre of the drive axle assembly, and may be of the drive axle housing, and up 10% or up to 20% of the total axial length in both axial directions from said axial centre.

In one example, the differential assembly has a pair of intersecting rotational axes about which its differential gears rotate. For example, a first and second rotational axis may be provided that may extend orthogonally to one another, for example with a pair of differential gears rotating about each of the axes. The axial central region of the drive axle assembly, and of the drive axle housing, may comprise an axial centre of the differential assembly and/or a point of intersection of the rotational axes discussed above.

Additionally or alternatively, the axial central region of the drive axle assembly, and for instance of the drive axle housing, may comprise the input shaft and/or the rotation axis of said input shaft.

It may be provided that the lubricant baffle is largely or completely positioned in said axial central region. Accordingly, it may be provided that it does not extend outside of said axial central region and/or its (for example axial) dimensions are limited to stay within said axial central region. For instance, the lubricant baffle may generally stay at an axial distance from any of the sidewalls or side covers of the drive axle housing. This may enable that the lubricant baffle can be used in a number of differently configured drive axle assemblies.

For example, an assembly comprising the drive axle housing and the lubricant baffle in an axial centre portion of said drive axle housing may be usable for configuring drive axle assemblies having the pinion gear and/or crown gear at either (axial) side of the lubricant baffle. In other words, the respective assembly can be used as a module to flexibly configure different types of drive axle assemblies. Said different types of drive axle assemblies may differ from one another with respect to a relative position of the lubricant baffle and the crown gear.

The presently proposed subject matter also relates to a set of drive axle assemblies, the set comprising a first drive axle assembly according to any of any of the disclosed embodiments and a second drive axle assembly according to any of the disclosed embodiments; wherein in the first set the crown gear is positioned on a first axial side of the pinion gear and in the second set the crown gear is positioned on a second axial side of the pinion gear that is opposite to the first side; wherein the lubricant baffle is positioned identically with respect to the drive axle housing in both of the first and second drive axle assembly. Again, this confirms that one and the same assembly of drive axle housing and lubricant baffle can be used for configuring a plurality of different types of drive axle assemblies.

In the following, embodiments of the presently proposed drive axle assembly are discussed with reference to the attached schematic figures. Throughout the figures, identical or similar features may be marked with same reference signs.

### BRIEF DESCRIPTION OF THE FIGURES

FIG. 1 is a sectional view of a drive axle assembly according to an embodiment of the presently proposed drive axle assembly.

FIG. 2 is another sectional view of the drive axle assembly according to the first embodiment.

FIG. 3 is another sectional view of the drive axle assembly according to the first embodiment.

### DETAILED DESCRIPTION

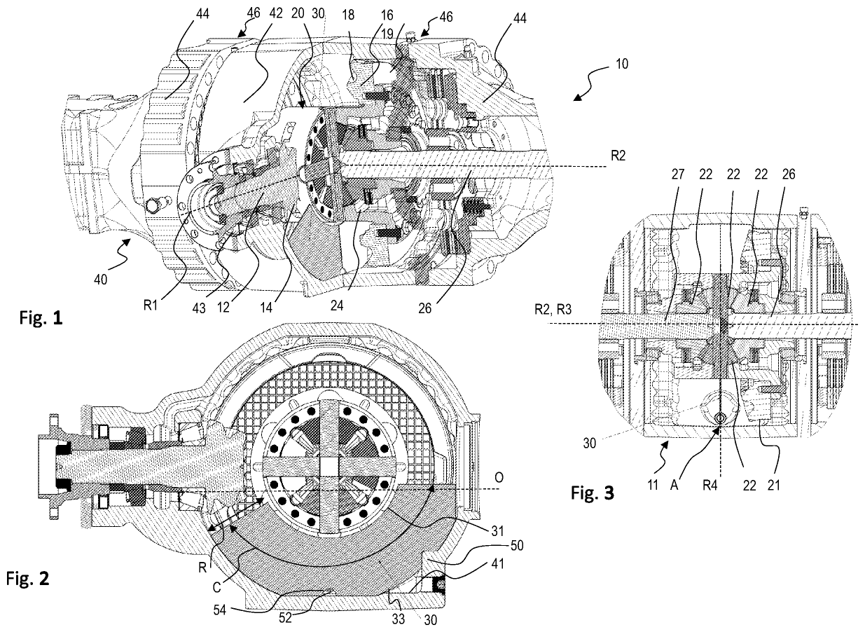

FIGS. 1-3 are sectional views, to scale, of a drive axle assembly 10 according to an embodiment of the presently proposed drive axle assembly, although other relative dimensions may be used if desired. More precisely, FIG. 1 is a partial sectional perspective view of said drive axle assembly 10. In FIG. 2 the sectional plane extends orthogonally to a rotation axis R2 of a crown gear 16, and in FIG. 3 the sectional plane comprises said rotation axis R2. The embodiment will be discussed with respect to all of said FIGS. 1-3, while certain features may be marked with an associated reference sign in only selected ones of FIGS. 1-3.

The drive axle assembly 10 comprises an input shaft 12 that rotates about a rotation axis R1. The input shaft 12 is coupled with a pinion gear 14 and is driven to rotate said pinion gear 14 about the rotation axis R1. The pinion gear 14 meshes with a crown gear 16. The pinion gear 14 and crown gear 16 define a bevel gear set.

In FIG. 1, a toothed front face 18 of the crown gear 16 faces to the left and an untoothed rear face 19 of the crown gear 16 faces to the right. The crown gear 16 is configured to rotate about a rotation axis R2. This rotation axis R2 serves as a reference for any axial, radial and circumferential direction referred to in this description. The rotation axis R2 of the crown gear 16 extends at an angle and may be orthogonally to the rotation axis R1 of the input shaft 12.

The pinion gear 14 and the crown gear 16 are part of a differential assembly 20. The differential assembly 20 further comprises differential gears 22 and a differential assembly cage 24 that is coupled or fixed to the crown gear 16.

The differential assembly 20 and more specifically its differential gears 22 are drivingly coupled to a first driven shaft 26 and to a second driven shaft 27 (see FIG. 3). Each of the first and second driven shaft 26, 27 are half axles that are drivingly coupled to non-illustrated vehicle wheels.

The drive axle assembly 10 further comprises a lubricant baffle 30 facing the front face 18 of the crown gear 16 and axially overlapping with the pinion gear 14 (see FIG. 1). The lubricant baffle 30 is a flat and smooth plate-shape member that, in the shown example, is substantially two dimensional. Accordingly, it defines a planar member whose main plane extends orthogonally to the rotation axis R2. As can be gathered from FIG. 2, the lubricant baffle 30 is also shaped corresponding to a ring segment. It has an arc-shaped radially inner edge 31. Its radially outer edge 33 is largely arc-shaped as well and only straightened along a limited lengths (e.g. at a position of contact to a lower wall 41 of the drive axle housing 40).

The lubricant baffle 30 has a circumferential dimension C and a radial dimension R which are both indicated in FIG. 2. The lubricant baffle also has an axial dimension A defining its thickness or material strength. The circumferential dimension is larger than the radial dimension (e.g. at least twice as large). The axial dimension is significantly smaller than any of the circumferential dimension C and radial dimension R. In the shown example, the axial dimension A amounts to less than 2% of any of said other dimensions.

Especially FIG. 2 shows that a circumferential extension of the lubricant baffle 30 or, in other words, an angular section covered by the first lubricant baffle 30 is between more than 90° and less than 180°, e.g. between 1000 and 160°. Yet, according to another embodiment, said angular section may be more than 180°, e.g. up to 220°, up to 2700 or more than 300°. For the sake of completeness, it is noted that the different light-dark colouring of the lubricant baffle 30 in FIG. 1 is for illustrative purposes only and without any structural significance. The lubricant baffle 30 is a one-piece member having a homogeneous material composition, for example comprising a plastic or metallic material, see FIG. 2.

All figures illustrate an orientation of the drive axle assembly 10 when mounted to a vehicle. Accordingly, it is evident that the lubricant baffle 30 is located in a vertically lower part of the drive axle assembly 10 and largely below of a static lubricant level indicated by a dashed line O in FIG. 2.

FIG. 1 also shows the drive axle housing 40. As an optional feature, the drive axle housing 40 has a main (or centre) part 42 comprising an opening 43 for receiving the input shaft 12. The main part 42 has opened axial end faces 46, to each of which an axial end cover 44 is fixed.

Even though not specifically illustrated in the Figures, the lubricant baffle 30 is fixed to the drive axle housing 40. For example, FIG. 2 shows an optional shoulder 50 that may be contacted by the lubricant baffle 30 and act as an axial stop element when inserting the lubricant baffle 30. Said shoulder 50 and lubricant baffle 30 may comprise non illustrated and e.g. axially extending through-holes through which a mechanical fixing element, such as a screw bolt, may be inserted. This, however, is just one non-limiting example. Other (non-illustrated) shoulders, protrusions or structural features of the drive axle housing 40 may be used for providing the mechanical fixation of the lubricant baffle 30 to the drive axle housing 40 as well.

FIGS. 1 and 3 both indicate that the lubricant baffle 30 is positioned in an axial centre region 11 of the drive axle housing 40. The lubricant baffle 30 also axially overlaps with the pinion gear 14 (see FIG. 1). In the shown example, this axial centre region 11 comprises a point of intersection between rotation axes R3, R4 of the differential assembly 20 (see FIG. 3). The lubricant baffle 30 does not extend axially beyond said axial centre region 11.

Especially from FIG. 3, it becomes evident that the crown gear 16 could also be located at the respective other side of the lubricant baffle 30 (and thus other (axial) side of the pinion gear 14) without having to rearrange or replace said lubricant baffle 30. That is, one and the same assembly of the drive axle housing 40 and the lubricant baffle 30 can be used to receive differently configured bevel gear sets formed by the pinion gear 14 and crown gear 16. This does not require a repositioning of the lubricant baffle 30, let alone a different size or shape thereof.

Still further, FIG. 2 shows a lower cut-out 52 at a (vertically) lower edge of the lubricant baffle 30. Said cut-out 52 defines a lubricant passage so that lubricant can cross the lubricant baffle 30 at a defined positioned. The cut-out 52 comprises an outer edge portion 54 of the lubricant baffle 30 that is at a distance from the opposite lower wall 41 of the drive axle housing 40.

FIGS. 1-3 show example configurations with relative positioning of the various components. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure

1. A drive axle assembly, comprising:
a differential assembly including a pinion gear and a crown gear, the pinion gear configured to drive the crown gear and the crown gear rotatable about a rotation axis, and
a lubricant baffle,
wherein the lubricant baffle axially overlaps with the pinion gear and faces a toothed front face of the crown gear, and
wherein the lubricant baffle has, with respect to the rotation axis of the crown gear, an axial dimension, a radial dimension and a circumferential dimension, the axial dimension being smaller than the radial dimension and the circumferential dimension.

2. The drive axle assembly of claim 1, wherein the lubricant baffle is plate shaped and/or has a shape substantially corresponding to a planar ring segment.

3. The drive axle assembly of claim 1, wherein the lubricant baffle does not extend past the toothed front face of the crown gear along the rotation axis.

4. The drive axle assembly of claim 1, wherein the lubricant baffle is axially distanced from the crown gear.

5. The drive axle assembly of claim 1, further including a drive axle housing, the differential assembly disposed within the drive axle housing, wherein the lubricant baffle is fixed to the drive axle housing at a position that is below a static lubricant level in the drive axle housing.

6. The drive axle assembly of claim 5, wherein a radial outer portion including a radial outer edge of the lubricant baffle is fixed to the drive axle housing.

7. The drive axle assembly of claim 1, wherein the lubricant baffle faces at least a segment of the toothed front face of the crown gear along a complete length of the teeth of said segment.

8. The drive axle assembly of claim 1, wherein the circumferential dimension of the lubricant baffle is less than 270°.

9. The drive axle assembly of claim 1, wherein a majority of the surface area of the lubricant baffle is below of a static lubricant level.

10. The drive axle assembly of claim 1, further including a drive axle housing, the differential assembly disposed within the drive axle housing, wherein the lubricant baffle comprises at least one outer edge portion distanced from an inner wall of the drive axle housing.

11. The drive axle assembly of claim 10, wherein said outer edge portion features a cut-out.

12. The drive axle assembly of claim 1, further including a drive axle housing, the differential assembly disposed within the drive axle housing, wherein the lubricant baffle is positioned in an axial central region of the drive axle housing.

13. The drive axle assembly of claim 12, wherein the axial central region comprises an axial center of the drive axle housing and up 20% of the total axial length of the drive axle housing in both axial directions from said axial center.

14. A set of drive axle assemblies, the set comprising a first drive axle assembly and a second drive axle assembly according to claim 1;
wherein in the first set the crown gear is positioned on a first axial side of the pinion gear and in the second set the crown gear is positioned on a second axial side of the pinion gear that is opposite to the first axial side;
wherein the lubricant baffle is positioned identically relative to the drive axle housing in both of the first and second drive axle assembly.
